(19) United States
(12) Patent Application Publication
(10) Pub. No.: US 2010/0187130 A1
(43) Pub. Date: Jul. 29, 2010

(54) Coagulants made in situ from sulfate-containing water and uses therewith

(75) Inventors: Kevin W. Smith, Magnolia, TX (US); Robert L. Sloan, Katy, TX (US)

Correspondence Address: William L. Krayer, 1771 Helen Drive, Pittsburgh, PA, 15216, US

(73) Assignee: Total Separation Solutions, LLC.

(21) Appl. No.: 12/657,821

(22) Filed: Jan. 28, 2010

Related U.S. Application Data
(60) Provisional application No. 61/206,288, filed on Jan. 29, 2009.

(51) Int. Cl. C02F 1/461

(52) U.S. Cl. 205/751; 205/742

(57) ABSTRACT

Acid mine drainage and surface waters containing sulfate are processed by an electrocoagulator to make aluminum or other polyvalent metal sulfate, which acts as a coagulant for solids suspended in the waters. The process thus removes and puts to good use highly undesirable sulfate anions, obviating combinations with barium and other scale forming metals when the fluids are used in well drilling for other purposes associated with hydrocarbon recovery. Well fluids may be treated with the acid mine drainage including the sulfate coagulant made in it. Efficiency of the process may be enhanced by the addition of an oxidizing agent and/or by passing the fluid through a cavitation device or other mechanism to improve mixing, enabling the process to handle large quantities of acid mine drainage and fluids handled in hydrocarbon recovery, particularly from shale formations.

### RELATED APPLICATION

This application claims the full benefit of Provisional application 61/206,288 filed Jan. 29, 2009.

### TECHNICAL FIELD

Acid mine drainage and surface waters containing sulfate are processed by an electrocoagulator or other electrolysis device to make aluminum sulfate, which acts as a coagulant for solids suspended in the waters. The process thus removes and puts to good use highly undesirable sulfate anions, obviating combinations with barium and other scale forming metals when the fluids are used in well drilling for other purposes associated with hydrocarbon recovery. Efficiency of the process may be enhanced by passing the fluid through a cavitation device or other mechanism to improve mixing, enabling the process to handle large quantities of acid mine drainage and fluids handled in hydrocarbon recovery, particularly from shale formations.

### BACKGROUND OF THE INVENTION

Acid mine drainage (AMD), commonly containing 50 ppm (parts by weight per million) sulfur or more in the form of sulfate or sulfuric acid, has long presented vexing problems for mine operators and for environmental regulators. Surface waters used in well drilling in various formations such as shale formations may also contain sulfate anions. Sulfate containing water presents a high risk of scale formation with barium, strontium and other polyvalent metals when injected into a well for various purposes. Carbonate anions also may be found in waters otherwise desirable for use in hydrocarbon recovery, but these also readily form scale when contacted with polyvalent metals downhole.

In the drilling of wells and the recovery of hydrocarbons from them, aqueous drilling fluids and other aqueous fluids are circulated to the bottom of the well to recover the drillings. Other fluids such as completion fluid, fracturing, workover and secondary recovery or flooding fluids may be injected into a well by the operator for various purposes well known in the art. If such fluids, which we singularly and collectively refer to herein as well fluids, contain high concentrations of sulfate anion, they are liable to form highly undesirable compounds with commonly available cations such as barium, strontium and calcium. Until now, it has been highly impractical to consider using AMD and other sources of water containing sulfates, themselves presenting difficult disposal problems, for use as well fluids.

In particular, our invention is directed to treating AMD and surface waters containing sulfates so they may be used as well fluids. The AMD and surface waters we treat will contain at least 10 ppm sulfur in the form of sulfate.

Our process is directed particularly to the treatment of sulfate containing fluids whether or not in the form of acid mine drainage (hereafter sometimes “AMD”). Some such fluids will contain other undesirable materials such as heavy metals (typically iron); scale-forming materials such as calcium, barium and strontium; oil; and high concentrations of halides, including alkali metal halides, mainly sodium salts, but also potassium chloride or bromide, and sometimes cesium bromide, any of which may have been used in a drilling fluid and have been returned to the surface. Frequently at least some of these materials are desirable for reuse; the heavier ones likely were placed in the drilling fluid to adjust its specific gravity to provide buoyancy for the drill cuttings. Such conditions have complicated efforts in the past to treat acid mine drainage and well fluids. Zinc, aluminum, iron, nickel, manganese, magnesium, cadmium and copper may be found in acid mine drainage. Some of these metal forms are toxic, and significant amounts of sulfuric acid are typical of acid mine drainage compositions. Accordingly acid mine drainage is a challenging problem for remediation and/or disposal. One common method is to add large quantities of lime in a settling pond, for example, to elevate the pH and encourage precipitation, but there is a need for a way to remove sulfate from acid mine drainage. There is also a need to find sources for well fluids which will not unnecessarily deplete fresh water sources in areas where hydrocarbon production is conducted. Inadequate conventional treatments create insoluble sulfates and carbonates downhole, blocking passages and fouling equipment.

### SUMMARY OF THE INVENTION

We remove the sulfates in AMD and other water sources, such as the SO₄⁼ anion of sulfuric acid, by combining them with aluminum or iron ions from the anode of an electrocoagulator or other electrolytic cell. The aluminum or iron sulfate thus made is used as a coagulant for solids in the same acid mine drainage or AMD mixed with a different aqueous fluid. The solids acted upon by the aluminum or ferric sulfate are generated at the same time, in the electrocoagulator.

We have found that by generating aluminum, iron, or other polyvalent metal cations from a sacrificial anode into a surface water or acid mine drainage containing at least 10 ppm sulfur in the form of sulfate, we form aluminum, iron or other sulfate, which functions as a coagulant for other solids present in the water; these coagulated solids can readily be removed by filtration, settling or other known methods of solids removal. Our invention is the in situ manufacture of aluminum sulfate, iron sulfate or other metal sulfate coagulant, followed by formation of flocs or coagulated compositions and their removal from the water by any suitable separation means.

More particularly, we are able to treat acid mind drainage and make fluids suitable for various uses in wells at the same time by generating aluminum sulfate, iron sulfate or other sulfate from the sulfate present in the AMD and using it to remove undesired materials from fluids for use in wells.

The principle of the electrocoagulator is well known—a number of electrodes, usually steel or aluminum, are placed in a vessel suitable for handling electrolysis, and a direct current is applied to the solution or dilute slurry within it. Usually the electrodes are disposed as alternate parallel plate anodes and cathodes. As the aqueous fluid flows through, the current causes ionic charges to be applied to the particles, colloids, heavy metal components, and the like, which facilitates oxidation, precipitation, flocculation, and other events tending to cause a separation of the contaminants from the aqueous carrier. As is known in the art of electrolysis, a certain level of electrolyte concentration is necessary for optimum operation of an electrolytic cell, and a similar principle is true of the electrocoagulator. An electrocoagulator in our invention is followed by one or more devices for collecting precipitants and the like; such devices include settling vessels, filters, and further chemical treatment vessels.

The electrocoagulator used in our invention may be of any practical size but may, for example, be adapted to handle high flow rates containing a variety of contaminants. For example, it may be able to handle a flow rate of 100 to 400 gallons per minute, although a wide variety of flow rates may be used in our invention, and more than one electrocoagulator may be used. For a typical flow rate of 200 gallons per minute (gpm), a generator or power source on site should be able to deliver 480 V (volts) and 400 amps (amperes). To prevent scale build up and to evenly wear the plates, the charge should be alternated every few minutes. When the phase changes, there is a surge, thus 400 ampere capability, or some other capability higher than the steady state current, is needed. Steady state treatment of 200 gpm normally may require about 200 amperes. We do not intend to be limited to electrocoagulators having the capabilities or specifications just mentioned; they can of course be somewhat smaller and considerably larger depending on the expected flow rates and other conditions; the principle of operation remains substantially the same.

Any electrolytic cell or device capable of handling a flow of aqueous fluid and generating aluminum, iron, or other suitable polyvalent metal ions can be used. Because electrocoagulators already exist in the marketplace, we use the term “electrocoagulator” to include any such electrolytic cell or unit, whether or not its expected use normally results in the formation of aluminum sulfate.

A small amount of oxygen or air can always be expected to be dissolved in the treated fluid from pumps and the like, and this oxygen is available to oxidize heavy metals at least to a degree under the appropriate conditions and/or to facilitate the formation of sulfates. Oxidation can be enhanced by the injection of an oxidizing agent (ozone, peroxide, or hypochlorite, for example) ahead of the electrocoagulator. Generally, up to about 100 ppm O₂ or equivalent will be used, but the amount will depend on operator's knowledge of conditions, such as the heavy metal content. Oxidizing agents will enhance the formation of heavy metal oxides; for example they will encourage the formation of ferric hydroxide and other insoluble forms of the heavy metal oxides, and these forms will be coagulated by the aluminum sulfate or iron sulfate, for example, rendering them easier to remove from the fluid. Injection of an oxidizing agent, for example air or oxygen, will also encourage the liberation of CO₂ gas from any carbonate present in the water. To the extent CO₂ is released, the formation of alkaline earth metal carbonates downhole is ameliorated.

### BRIEF DESCRIPTION OF THE DRAWINGS

FIG. 1 shows, in conceptual form, the disposition of the electrodes in an electrocoagulator useful in our invention.

### DETAILED DESCRIPTION OF THE INVENTION

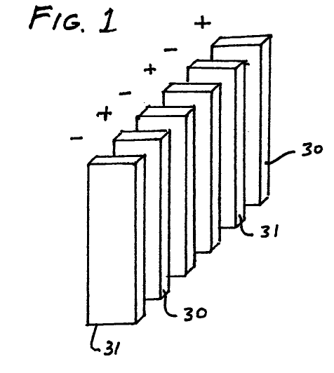

FIG. 1 depicts the disposition of the electrodes in an electrocoagulator of a type suitable for our invention. The vessel or housing is not shown; nor is the fluid to be treated. The vessel or housing should have a suitable entrance and a suitable exit for the fluid, and should be able to accommodate the rather high flow rates contemplated by the process. Parallel electrodes 30 and 31 are desirably, but need not be, completely submerged in the fluid, and are given alternate positive and negative functions under direct current Here it is seen that the electrodes 30 are positively charged and electrodes 31 are negatively charged. Being made of aluminum, the anodes will tend to erode as sacrificial anodes. In order to balance this effect, the current is reversed periodically, typically every few minutes; reversing the current will also minimize scale formation on the electrodes.

Desirably the gaps between the electrodes will be adjustable so the operator can obtain optimum benefit for different compositions of fluid. As indicated above, the power requirements (current) will surge each time the phase is changed, and accordingly assumptions about steady state may not suffice when designing the electrocoagulator. The operator will wish to avoid conditions likely to generate chlorine gas where significant amounts of chlorine (chloride) are present.

### Example 1

In the below described experiment, the compositions of the fluids were:

| | AMD | Well |
|---|---|---|
| Property | Untreated | Untreated |
| Color | orange | Orange |
| Odor | none | None |
| Sediment | fine | Fine |
| Density | 1.006 | 1.112 |
| pH | 6.8 | 4.96 |
| Iron | 25 ppm | 100 ppm |
| Chlorides | 60 ppm | |
| Hardness | 490 ppm | |
| Sulfate | 750 ppm | 90 ppm |

The acid mine drainage (AMD) was passed through an electrocoagulator having aluminum electrodes using 26 volts and 8 amperes for periods of either 30 seconds or 2 minutes, as indicated below. In a separate run, the well water (a Marcellus shale flowback brine) was passed through at 7 volts and 25 amperes. This well fluid was combined with the untreated AMD in a ratio of 75% AMD and 25% well fluid, and passed through, with the results indicated below. Aluminum sulfate was formed in the AMD and was instrumental in reducing sulfate in both fluids.

| | | |
|---|---|---|
| AMD Untreated | filtered only | 625 Ppm |
| | | Sulfate |
| AMD Untreated | EC-30 sec, filtered | 500 Ppm |
| | | Sulfate |
| AMD Untreated | EC-2 min, filtered | 375 Ppm |
| | | Sulfate |
| 75% AMD-U*, 25% | EC-2 min, filtered | 125 Ppm |
| Well | | Sulfate |
| 75% AMD-U*, 25% | EC-2 min | 100 Ppm |
| Well | | Sulfate |

*AMD-U is acid mine drainage untreated

The Marcellus shale flowback brine tended to increase the electrolyte concentration of the mixed fluid, thus enhancing the efficiency of the electrocoagulator. When using various shale flowback fluids, operators may wish to monitor its radioactive content.

Efficiency of sulfate coagulant production and its usage is a function of residence time in the electrocoagulator and accordingly recycling can be used to good effect. Recycling through the electrocoagulator is a part of our invention. Small or large portions of the fluid, mixed or not, can be recycled. Any portion of the electrocoagulator output from 5% to 95% could be a useful recycle ratio within the operator's discretion depending on concentrations of various components of the fluids, temperature, pH, and other factors such as the volume needed in the well operation.

Before or after treatment in the electrocoagulator, the fluid may be sent to a cavitation device, which functions as an intimate mixer which will also elevate the temperature somewhat. It is particularly good at promoting the oxidation reaction of heavy metals present in the fluid. In the cavitation device, the increased temperature and the intimate mixing may assure completion of reaction such as the formation of aluminum sulfate.

Preferably the cavitation device is one manufactured and sold by Hydro Dynamics, Inc., of Rome, Ga., most preferably the device described in U.S. Pat. Nos. 5,385,298, 5,957,122 6,627,784 and particularly 5,188,090, all of which are incorporated herein by reference in their entireties. The cavitation device is part of a larger class of process intensifiers available for use. Any device that will increase the efficiency of formation of the sulfate coagulant may be used. Generally any device designed to promote intimate mixing or multiply the surface area of the reactants may be used.

Polymers may be added before or after formation of floc to aid in filtration or other separation steps. Possible separation devices include lamella gravity settlers, tube settlers, and various filters. Scale inhibitors and biocides may be added to the cleaned fluid prior to use in a well or for other purposes.

Thus it is seen that our invention includes a method of treating an aqueous fluid containing at least 10 ppm sulfate comprising passing said fluid into an electrocoagulator having sacrificial electrodes made of polyvalent metal, thereby generating polyvalent metal ions in said fluid, said polyvalent metal ions being capable of forming a polyvalent metal sulfate coagulant, maintaining conditions in said fluid to cause said ions to combine with sulfate in said fluid to form a polyvalent metal sulfate coagulant, and utilizing said coagulant as a coagulant in said fluid. Effective polyvalent metal electrodes include particularly iron and aluminum electrodes.

In another aspect, our invention includes a method of treating a well fluid comprising (a) passing acid mine drainage having a sulfate content in the form of SO₄⁼ of at least 10 ppm into an electrocoagulator having sacrificial aluminum electrodes, (b) generating aluminum ions in said acid mine drainage from said sacrificial aluminum electrodes, (c) maintaining conditions in said acid mine drainage to cause said aluminum ions to combine with SO₄⁼ in said acid mine drainage to form aluminum sulfate, and (d) utilizing said aluminum sulfate as a coagulant in said well fluid. Desirably, the current is periodically reversed through the electrocoagulator. To effect coagulation of particulates in the well fluid, it is mixed with the acid mine drainage containing the aluminum sulfate coagulant.

Our invention also includes a method of utililzing acid mine drainage containing at least 10 ppm SO₄⁼ ions to reduce the content of polyvalent metals in a well fluid containing polyvalent metals, in preparation for use of said well fluid in a well comprising substantially continuously (a) passing said acid mine drainage through an electrocoagulator having sacrificial aluminum anodes to generate aluminum sulfate coagulant from aluminum ions emanated from said sacrificial anodes in said electrocoagulator and SO₄⁼ ions in said acid mine drainage, and (b) mixing said acid mine drainage containing said aluminum sulfate coagulant with said well fluid and coagulating said polyvalent metals with said aluminum sulfate coagulant, and (c) separating said polyvalent metals and aluminum sulfate coagulant from said well fluid. The polyvalent metals that are separated from the well fluid may include notably iron, barium, and strontium; in addition, polyvalent metals present in the acid mine drainage, such as zinc, manganese, and cadmium may be separated at the same time, thus enabling the successful use of the acid mine drainage as a well fluid.

1. Method of treating an aqueous fluid containing at least 10 ppm sulfate comprising passing said fluid into an electrocoagulator having sacrificial electrodes made of polyvalent metal, thereby generating polyvalent metal ions in said fluid, said polyvalent metal ions being capable of forming a polyvalent metal sulfate coagulant, maintaining conditions in said fluid to cause said ions to combine with sulfate in said fluid to form a polyvalent metal sulfate coagulant, and utilizing said coagulant as a coagulant in said fluid.

2. Method of claim 1 followed by separating solids coagulated by said coagulant from said fluid.

3. Method of claim 2 wherein said separating comprises filtering.

4. Method of claim 1 followed by collecting solids and precipitates in a settling tank.

5. Method of claim 1 including recycling a portion of said fluid to said electrocoagulator.

6. Method of claim 1 wherein said electrocoagulator comprises a plurality of parallel plane cathodes and sacrificial anodes under a direct current.

7. Method of claim 6 including periodically converting said cathodes to sacrificial anodes and said sacrificial anodes to cathodes.

8. Method of claim 1 including injecting an oxidizing agent into said fluid prior to or introducing said fluid to said electrocoagulator or into said electrocoagulator.

9. Method of claim 8 including removing carbon dioxide gas from said fluid.

10. Method of treating a well fluid comprising (a) passing acid mine drainage having a sulfate content in the form of SO₄⁼ of at least 10 ppm into an electrocoagulator having sacrificial aluminum electrodes, (b) generating aluminum ions in said acid mine drainage from said sacrificial aluminum electrodes, (c) maintaining conditions in said acid mine drainage to cause said aluminum ions to combine with SO₄⁼ in said acid mine drainage to form aluminum sulfate, and (d) utilizing said aluminum sulfate as a coagulant in said well fluid.

11. Method of claim 10 including mixing said acid mind drainage and said well fluid prior to or while passing them through said electrocoagulator.

12. Method of claim 10 followed by filtering said well fluid.

13. Method of claim 11 followed by filtering said mixed AMD and well fluid.

14. Method of claim 10 including recycling at least a portion of said acid mine drainage through said electrocoagulator.

15. Method of claim 10 including adding oxygen to said acid mine drainage.

16. Method of claim 10 including, during step (c), passing said acid mine drainage through a cavitation device to intensify said formation of aluminum sulfate.

17. Method of utililzing acid mine drainage containing at least 10 ppm SO₄⁼ ions to reduce the content of polyvalent metals in a well fluid containing polyvalent metals, in preparation for use of said well fluid in a well comprising substantially continuously (a) passing said acid mine drainage through an electrocoagulator having sacrificial aluminum anodes to generate aluminum sulfate coagulant from aluminum ions emanated from said sacrificial anodes in said electrocoagulator and SO₄⁼ ions in said acid mine drainage, and (b) mixing said acid mine drainage containing said aluminum sulfate coagulant with said well fluid and coagulating said polyvalent metals with said aluminum sulfate coagulant, and (c) separating said polyvalent metals and aluminum sulfate coagulant from said well fluid.

18. Method of claim 17 including separating, in step (c), at least partially by a filter.

19. Method of claim 17 including, in step (a), substantially continuously recycling at least a portion of said acid mine drainage through said electrocoagulator.

20. Method of claim 17 including mixing, in step (b), at least partially in a cavitation device.
